(19) United States
(12) Patent Application Publication
(10) Pub. No.: US 2016/0195654 A1
(43) Pub. Date: Jul. 7, 2016

(54) OPTICAL FILM, PROCESS FOR PRODUCING THE SAME AND POLARIZING PLATE USING THE SAME, LIQUID CRYSTAL DISPLAY DEVICE USING THE SAME AND POLARIZING PROJECTION SCREEN USING THE SAME

(71) Applicant: JX NIPPON OIL & ENERGY CORPORATION, Tokyo (JP)

(72) Inventors: Gorou SUZAKI, Tokyo-to (JP); Suzushi NISHIMURA, Tokyo-to (JP); Akira MATSUO, Tokyo-to (JP)

(73) Assignee: JX NIPPON OIL & ENERGY CORPORATION, Tokyo (JP)

(21) Appl. No.: 14/780,709

(22) PCT Filed: Mar. 27, 2014
(86) PCT No.: PCT/JP2014/058718

§ 371 Date: Mar. 15, 2016

(30) Foreign Application Priority Data
Mar. 29, 2013 (JP) 2013-072289

(51) Int. Cl. G02B 5/30; G03B 21/604; B29D 11/00; G02B 1/08; B29C 47/00; G02B 5/02; G02F 1/13363

(52) U.S. Cl. CPC G02B 5/3016; G02B 5/0242; G03B 21/604; G02F 1/13363; G02B 1/08; B29C 47/0021; B29D 11/00788

(57) ABSTRACT

To provide an optical film that can transmit one of orthogonal polarized components and scatter the other one thereof and a process for producing the optical film. An optical film includes an optically isotropic continuous phase and an optically anisotropic dispersed phase, in which the optically isotropic continuous phase has a birefringence of below 1.5×10⁻⁴; a ratio: L₁/L₂ of a mean Feret diameter L₁ of the optically anisotropic dispersed phase in one direction D₁ of in-plane directions of the optical film to a mean Feret diameter L₂ of the optically anisotropic dispersed phase in a direction D₂ orthogonal to the direction D₁ is 2.5 or more; and the mean Feret diameter L₂ is 0.5 μm or less.

### BACKGROUND OF THE INVENTION

1. Field of the Invention

The present invention relates to an optical film and a process for producing thereof, and more particularly to an optical film suitably usable for polarizing plates, liquid crystal display devices, and polarizing projection screens, and to a process for producing the optical film.

2. Background Art

Conventionally, liquid crystal display devices use an absorption type polarizing plate. The absorption type polarizing plate absorbs only one of orthogonal polarized components in light from a backlight, whereby only a specific polarized component is supplied to liquid crystal cells.

In the light from the backlight input to the absorption type polarizing plate, the one of the polarized components is all absorbed by the absorption type polarizing plate, causing use efficiency of the light from the backlight to drop below 50%.

Thus, recent years have seen efforts to improve light use efficiency by disposing a brightness enhancement film on a light source side of a polarizing plate (for example, Patent Literature 1 to 3)

The brightness enhancement film is a film that allows scattering of a polarized component that is to be absorbed by a polarizing plate to a backlight side, while allowing transmission of a polarized component that is to be transmitted therethrough. Light scattered to the backlight side is reflected by a reflecting film or the like and supplied again to the brightness enhancement film. Repeating the scattering and the reflection to change the direction of light polarization can increase the amount of light of the polarized component that transmits through the polarizing plate, so that light from the backlight can be efficiently supplied to liquid crystal cells.

In addition, there is known a projection screen that displays a desired image by projecting image light having polarized light from a front side (an observer side) or a back side (for example, Patent Literature 4 and 5). Such a polarizing projection screen has a reflection type polarizing layer formed therein so that only polarized image light can be reflected and scattered to allow projection of an image. Thus, the screen can prevent contrast deterioration caused by projection of unpolarized ambient light (such as, for example, external light) onto the screen.

### CITATION LIST

### Patent Literature

Patent Literature 1: Japanese Unexamined Patent Application Publication No. 2008-249970

Patent Literature 2: Japanese Unexamined Patent Application Publication No. 2003-207631

Patent Literature 3: Japanese Unexamined Patent Application Publication No. 2003-043260

Patent Literature 4: Japanese Unexamined Patent Application Publication No. 2002-540445

Patent Literature 5: Japanese Unexamined Patent Application Publication No. 2005-107096

### SUMMARY OF THE INVENTION

### Technical Problems

The inventors have recently found that when an optically isotropic polymer with small birefringence is used as a continuous phase and an optically anisotropic polymer is dispersed in the continuous phase, controlling a dispersion form of the optically anisotropic polymer to form a film allows obtaining of a film that can transmit one of orthogonal polarized components and scatter the other one thereof. Then, they have found that the use of the film as a brightness enhancement film of a liquid crystal display device can improve use efficiency of light from a light source. In addition, it has been found that the film can be used as a reflection type polarizing layer of a polarizing projection screen and can further widen a viewing angle of a projected image as compared to the conventional reflection type polarizing layer.

Accordingly, it is an object of the present invention to provide an optical film that can transmit one of orthogonal polarized components and scatter the other one of the orthogonal components and a process for producing the optical film. In addition, it is another object of the invention to provide a polarizing plate and a liquid crystal display device that include the optical film having an excellent brightness enhancement effect. Furthermore, it is still another object of the invention to provide a polarizing projection screen that can project a clear image hardly affected by ambient light.

### Solution to the Problems

An optical film according to the present invention is an optical film including an optically isotropic continuous phase and an optically anisotropic dispersed phase, in which:

the optically isotropic continuous phase has a birefringence of below 1.5×10⁻⁴;

a ratio: L₁/L₂ of a mean Feret diameter L₁ of the optically anisotropic dispersed phase in one direction D₁ of in-plane directions of the optical film to a mean Feret diameter L₂ of the optically anisotropic dispersed phase in a direction D₂ orthogonal to the direction D₁ is 2.5 or more; and the mean Feret diameter L₂ is 0.5 μm or less.

The optical film of the present invention can transmit one of orthogonal polarized components and scatter the other one thereof, so that a brightness enhancement effect in a liquid crystal display device can be remarkably obtained.

In one embodiment, the direction D₁ may be a machine direction MD of the optical film and the direction D₂ may be a transverse direction TD of the optical film.

In one embodiment, the optically anisotropic dispersed phase may include a bar-shaped liquid crystal polymer.

In one embodiment, preferably, a refractive index N₁ of a resin forming the optically isotropic continuous phase,

a refractive index N₂ in an orientation direction in which the bar-shaped liquid crystal polymer is oriented on an orientation substrate, and a refractive index N₃ in a direction orthogonal to the orientation direction in a plane including the orientation direction satisfy the following formulae (A-1) and (A-2):

N₂−N₁>0.19 (A-1)

|N₁−N₃<0.09 (A-2).

In one embodiment, preferably, a difference |T₁−T₂| between a glass transition temperature T₁ of the resin forming the optically isotropic continuous phase and a glass transition temperature T₂ of the resin forming the optically anisotropic dispersed phase is below 25° C.

In addition, a process for producing an optical film according to another aspect of the invention includes a film forming step of forming a film by melting a resin material that includes a first resin forming the optically isotropic continuous phase and a second resin forming the optically anisotropic dispersed phase and continuously discharging the resin material from a T die.

According to the process of the invention, an optical film having a ratio: L₁/L₂ of 2.5 or more can be easily obtained with high productivity.

In one embodiment, at the film forming step, the resin material discharged from the T die can be extended and deformed so that a ratio: d₂/d₁ of a film thickness d₂ of a film to be formed to a lip clearance d₁ of the T die is below 0.5. Thereby, an optical film having a ratio: L₁/L₂ of 2.5 or more can be obtained more surely.

In one embodiment, the process may further include a stretching step of at least unidirectionally stretching the film formed at the film forming step. Such a stretching step can improve mechanical strengths (tearing resistance and folding endurance) of the optical film.

According to still another aspect of the present invention, there is also provided a polarizing plate including the optical film and an absorption type polarizer. In addition, according to still another aspect of the invention, there is also provided a liquid crystal display device including the optical film. Such a polarizing plate and such a liquid crystal display device can achieve high light use efficiency due to the brightness enhancement effect by the optical film of the invention.

In addition, according to still another aspect of the present invention, there is also provided a polarizing projection screen including the optical film. The use of the optical film of the invention as the polarizing projection screen allows image light from a polarizing projector to be clearly projected without being affected by ambient light, as well as allows a viewing angle of the projected image to be further widened as compared to the reflection type polarizing layer used in the conventional projection screens.

### Advantageous Effects of the Invention

The present invention provides an optical film that transmits one of orthogonal polarized components and scatters the other one of the polarized components and a process for producing the optical film.

### BRIEF DESCRIPTION OF THE DRAWINGS

FIG. 1 is a perspective view showing an optical film according to a first embodiment of the present invention;

FIG. 2(a) is a schematic sectional view showing a section taken along line I-I of the film according to the first embodiment; and FIG. 2(b) is a schematic sectional view showing a section taken along line II-II of the film according to a second embodiment;

FIG. 3 is a schematic view showing a projection view of a dispersed phase observed from a direction perpendicular to in-plane directions of the optical film in the first embodiment; and

FIG. 4 are scanning electron micrographs of sections of an optical film obtained in Example 1.

### DETAILED DESCRIPTION OF THE INVENTION

Hereinafter, embodiments of the present invention will be described in detail with reference to the drawings. However, the invention is not limited to the embodiments below.

### (Optical Film)

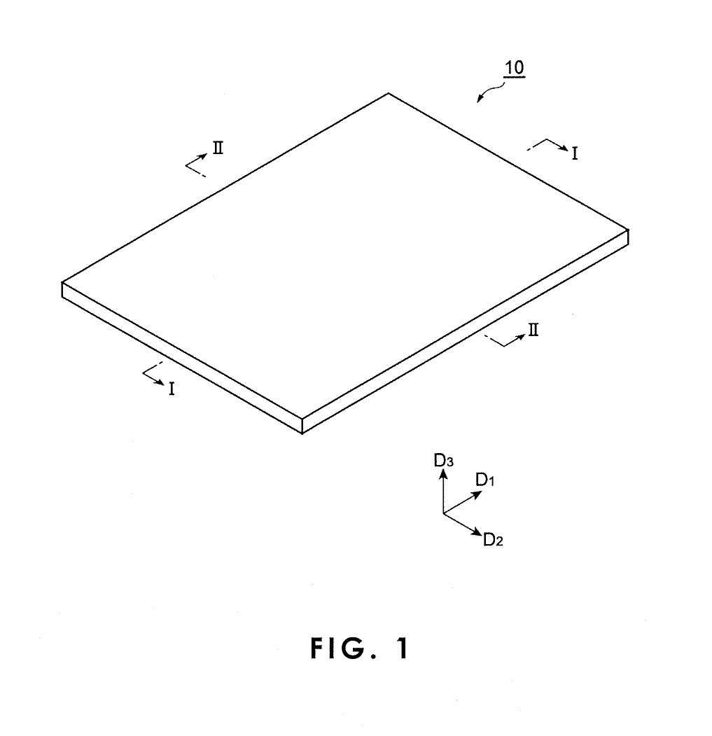

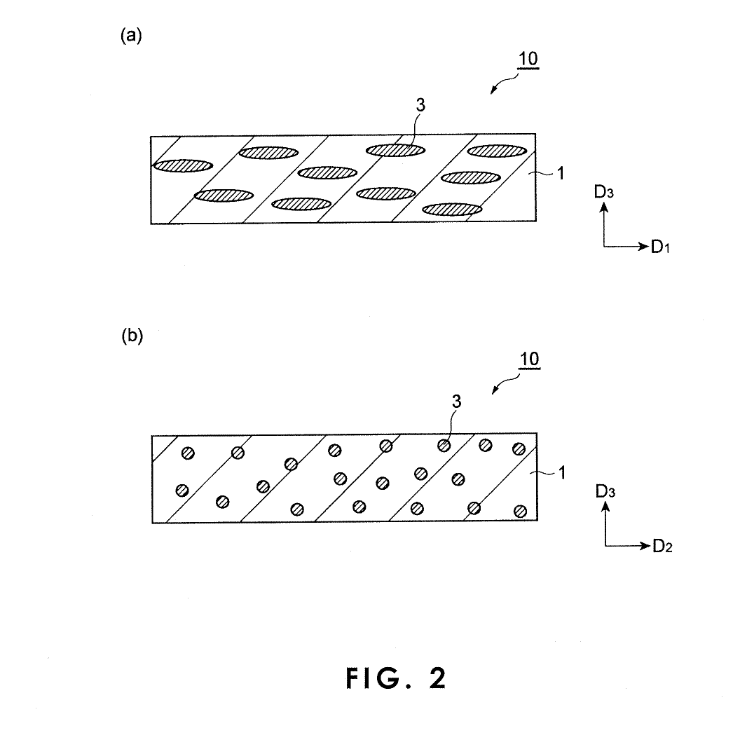

FIG. 1 is a perspective view showing an optical film according to a first embodiment of the present invention; FIG. 2(a) is a schematic sectional view showing a section taken along line I-I of the optical film according to the first embodiment; and FIG. 2(b) is a schematic sectional view showing a section taken along line II-II of the optical film according to the first embodiment.

An optical film 10 shown in FIG. 1 includes an optically isotropic continuous phase 1 (hereinafter simply referred to as “continuous phase 1” in some cases) and an optically anisotropic dispersed phase 3 (hereinafter simply referred to as “dispersed phase 3” in some cases) dispersed and present in the continuous phase 1.

The continuous phase 1 is a phase having optical isotropy and has a birefringence of below 1.5×10⁻⁴. The birefringence of the continuous phase 1 is preferably below 1.2×10⁻⁴, and more preferably below 1.15×10⁻⁴. Such a birefringence can be achieved by forming the continuous phase 1 from a resin having a small intrinsic birefringence index. When the birefringence index of the continuous phase 1 is below 1.5×10⁻⁴, a refractive index difference between the continuous phase 1 and the dispersed phase 3 in one direction D₁ of in-plane directions of the optical film 10 can be made larger, while a refractive index difference therebetween in a direction D₂ orthogonal to the direction D₁ can be made smaller. Thereby, there can be obtained a remarkable effect that allows an optical film having an excellent brightness enhancement effect to be easily produced.

The dispersed phase 3 is a phase having optical anisotropy, dispersed in the continuous phase 1. The dispersed phase 3 has a shape in which a ratio: L₁/L₂ of a mean Feret diameter L₁ of the dispersed phase 3 in the one direction D₁ of the in-plane directions of the optical film to a mean Feret diameter L₂ thereof in the one direction D₂ of the in-plane directions of the optical film 10, which is orthogonal to the direction D₁, is 2.5 or more. Additionally, the mean Feret diameter L₂ of the dispersed phase 3 is 0.5 μm or less.

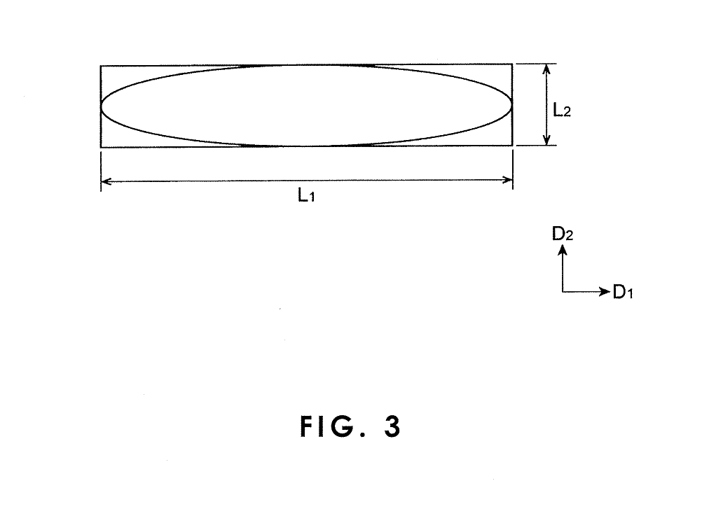

Herein, in a projection view of the dispersed phase 3 observed from a direction D₃ perpendicular to the in-plane directions of the optical film 10, when a rectangular shape that has two sides parallel to the direction D₁ and two sides parallel to the direction D₂ and is circumscribed with the dispersed phase 3 is drawn, a length of the sides parallel to the direction D₁ represents a Feret diameter L₁ and a length of the sides parallel to the direction D₂ represents a Feret diameter L₂. FIG. 3 is a schematic view showing a projection view of the dispersed phase 3 observed from the direction perpendicular to the in-plane directions of the optical film.

In addition, the mean Feret diameter L₁ of the optical film can be estimated as follows. In a section parallel to the direction D₁ of the optical film 10 (i.e., a section taken along line I-I), when the dispersed phase 3 is sandwiched by two line segments perpendicular to the direction D₁, a distance I₁ between the line segments is obtained. The distances with regard to a plurality of (for example, 10 or more) dispersed phases 3 are obtained, and a mean value of the distances can be used as a mean Feret diameter L₁.

In addition, the mean Feret diameter L₂ of the optical film can be estimated as follows. In a section parallel to the direction D₂ of the optical film 10 (i.e., a section taken along line II-II), when the dispersed phase 3 is sandwiched by two line segments perpendicular to the direction D₂, a distance I₂ between the line segments is obtained. The distances with regard to a plurality of (for example, 10 or more) dispersed phases 3 are obtained, and a mean value of the distances can be used as a mean Feret diameter L₂.

The optical film 10 formed by dispersing such a dispersed phase 3 in the continuous phase 1 can sufficiently scatter a polarized component of the direction D₁ and can sufficiently transmit a polarized component of the direction D₂ in light input to the optical film 10. Thus, the optical film 10 can be suitably used as a brightness enhancement film to be applied to a polarizing plate.

The ratio: L₁/L₂ of the mean Feret diameters of the dispersed phase 3 is preferably 5 or more, and more preferably 10 or more. With such a dispersed phase 3, the brightness enhancement effect can be obtained more remarkably.

The mean Feret diameter L₂ of the dispersed phase 3 is 0.5 μm or less, preferably 0.3 μm or less, and more preferably 0.1 μm or less. When the mean Feret diameter L₂ exceeds 0.5 μm, transmission of the polarized component of the direction D₂ is inhibited, and thereby the brightness enhancement effect tends to be reduced.

In suitable one embodiment, the direction D₁ is a flow direction (machine direction MD) of the optical film 10, and the direction D₂ is a widthwise direction (transverse direction TD) perpendicular to the machine direction of the optical film 10.

A resin forming the continuous phase 1 (hereinafter referred to as “first resin” in some cases” can be any as long as it is a resin that can achieve a birefringence of below 1.5×10⁻⁴. The resin is preferably a resin having a light transmittance of 80% or more, and more preferably a resin having a light transmittance of 90% or more.

In addition, the first resin forming the continuous phase 1 preferably includes a thermoplastic resin. Examples of the thermoplastic resin include polyolefins (for example, polyethylene, polypropylene, polymethyl pentene, and ethylene-propylene copolymers), norbornane resins, polyesters (for example, polyethylene terephthalate, polyethylene naphthalate, poly-1,4-cyclohexane dimethylene terephthalate, polyethylene-1,2-diphenoxyethane-4,4′-dicarboxylate, and polybutylene terephthalate), polycarbonates, polystyrenes (for example, syndiotactic polystyrene), acrylonitrile-styrene copolymers (AS resins), polyarylates, polysulfones, polyether sulfones, polyvinyl chlorides, polyvinyl alcohols, cellulose esters (for example, triacetyl cellulose, diacetyl cellulose, propionyl cellulose, butyryl cellulose, acetyl propionyl, cellulose, and nitrocellulose), polyamides (for example, nylon and aromatic polyamide), polyether imides, acryl resins (for example, polymethyl methacrylate), polyether ketones, polyphenylene sulfides, polyvinylidene chlorides, polyvinyl butyrals, and polyoxymethylenes. Examples of commercially available polymers usable as these thermoplastic resins include ZEONEX (manufactured by Zeon Corporation), ZEONOR manufactured by Zeon Corporation), ARTON (manufactured by JSR Corporation), and FUJITAC (manufactured by Fuji Film Co., Ltd). The thermoplastic resins can be used singularly or in combination of two or more thereof. In addition, a low molecular weight additive may be added to the thermoplastic resin(s). As the low molecular weight additive, an antioxidant, an ultraviolet ray absorbent, a compatibilizer, a dispersant, and a refractive index adjuster can be used.

In addition, in a suitable one embodiment, the first resin is an acrylic polymer. Hereinafter, a detailed description will be given of an acrylic polymer suitably used as the first resin.

The acrylic polymer suitably used as the first resin is one that includes a (meth)acrylate ester unit (b) as a structural unit, and preferably includes an N-substituted maleimide unit (a) and a (meth)acrylate ester unit (b) as structural units. The N-substituted maleimide unit (a) has a molecular structure that provides positive intrinsic birefringence to the acrylic polymer.

An example of the N-substituted maleimide unit (a) that provides positive intrinsic birefringence to the acrylic polymer is an N-alkyl-substituted maleimide or an N-aromatic-substituted maleimide. An alkyl group or an aromatic group as a substituent may be, for example, an alkyl group or an aromatic group having 1 to 20 carbon atoms, and may have a linear, branched, or cyclic structure.

Examples of the N-alkyl-substituted maleimide unit include structural units derived from monomers such as N-methyl maleimide, N-ethyl maleimide, N-isopropyl maleimide, N-n-butyl maleimide, N-isobutyl maleimide, N-t-butyl maleimide, N-n-hexyl maleimide, N-2-ethylhexyl maleimide, N-dodecyl maleimide, N-lauryl maleimide, and N-cyclohexyl maleimide. Examples of the N-aromatic-substituted maleimide unit include structural units derived from monomers such as N-phenyl maleimide and N-benzyl maleimide.

The acrylic polymer may include one N-substituted maleimide unit (a) or two or more N-substituted maleimide units (a). Among the N-substituted maleimide units (a), N-cyclohexyl maleimide units or N-phenyl maleimide units are preferable from the viewpoint of heat stability and optical characteristics of the optical film.

In addition, some N-aromatic-substituted maleimide units provide negative intrinsic birefringence to the acrylic polymer. Examples of such N-aromatic-substituted maleimide units include N-chlorophenyl maleimide units, N-methylphenyl maleimide units, N-methoxyphenyl maleimide units, and N-naphthyl maleimide units. The acrylic polymer may include any of the N-aromatic-substituted maleimide units that provide negative intrinsic birefringence thereto, and the content thereof is preferably 40% by mass or less with respect to the N-substituted maleimide unit (a) that provides positive intrinsic birefringence to the acrylic polymer.

The (meth)acrylate ester unit (b) is a structural unit that provides negative intrinsic birefringence to the acrylic polymer.

In the acrylic polymer, the N-substituted maleimide unit (a) serves to provide positive intrinsic birefringence, whereas the (meth)acrylate ester unit (b) serves to provide negative intrinsic birefringence. Due to this, in the acrylic polymer including both of these structural units, the birefringences caused by both of the structural units cancel each other out at a stretching step to be described later, thereby allowing the formation of the continuous phase 1 having an extremely small birefringence.

The (meth)acrylate ester unit (b) is not particularly limited as long as it serves to provide negative intrinsic birefringence to the polymer. Examples of the (meth)acrylate ester unit (b) include structural units derived from monomers such as methyl (meth)acrylate, ethyl (meth)acrylate, n-propyl (meth)acrylate, isopropyl (meth)acrylate, n-butyl (meth)acrylate, t-butyl (meth)acrylate, n-hexyl (meth)acrylate, 2-ethylhexyl (meth)acrylate, cyclohexyl (meth)acrylate, phenyl (meth)acrylate, naphthyl (meth)acrylate, benzyl (meth)acrylate, chloromethyl (meth)acrylate, 2-chloromethyl (meth)acrylate, phenoxyethyl (meth)acrylate, 2-hydroxyethyl (meth)acrylate, 3-hydroxypropyl (meth)acrylate, 2,3,4,5,6-pentahydroxyhexyl (meth)acrylate, and 2,3,4,5-tetrahydroxypentyl (meth)acrylate.

The acrylic polymer may include one or two or more of these (meth)acrylate ester units (b). From the viewpoint of heat stability and optical characteristics of the optical film, the (meth)acrylate ester unit (b) is particularly preferably a methyl methacrylate (MMA) unit.

The content percentage of the N-substituted maleimide unit (a) in the acrylic polymer is preferably 5% by mass or more and 30% by mass or less, more preferably 5% by mass or more and 25% by mass or less, still more preferably 8% by mass or more and 22% by mass or less, and particularly preferably 10% by mass or more and 22% by mass or less, based on a total amount of the acrylic polymer.

The content percentage of the (meth)acrylate ester unit (b) in the acrylic polymer is preferably 70% by mass or more and 95% by mass or less, more preferably 75% by mass or more and 95% by mass or less, still more preferably 78% by mass or more and 92% by mass or less, and particularly preferably 78% by mass or more and 90% by mass or less, based on the total amount of the acrylic polymer.

When the content percentages of the N-substituted maleimide unit (a) and the (meth)acrylate ester unit (b) in the acrylic polymer are within the above-mentioned ranges, there can be obtained an optical film having better optical characteristics and higher heat resistance. Also, in addition to that, in-plane phase difference Re and thickness direction phase difference Rth caused by stretching are sufficiently suppressed, so that a further brightness enhancement effect can be expected.

The acrylic polymer has a weight average molecular weight of preferably from 2.0×10³ to 1.0×10⁶, more preferably from 1.0×10⁴ to 5.0×10⁵, and still more preferably from 5.0×10⁴ to 3.0×10⁵.

Additionally, in the present specification, the weight average molecular weight of the acrylic polymer represents a value measured in terms of standard polystyrene molecular weight by HLC-8220 GPC manufactured by Tosoh Corporation. In addition, columns used in GPC can be Super-Multipore HZ-M manufactured by Tosoh Corporation, and measurement conditions can be tetrahydrofuran (THF) for HPLC as a solvent; a flow rate of 0.35 ml/min; and a column temperature of 40° C.

The acrylic polymer may further include a structural unit (c) other than the N-substituted maleimide unit (a) and the (meth)acrylate ester unit (b). The content of the structural unit (C) is preferably from 0 to 10% by mass, more preferably from 0 to 5% by mass, still more preferably from 0 to 2% by mass, and particularly preferably from 0 to 1% by mass.

The structural unit (C) in the acrylic polymer is a structural unit derived from a monomer polymerizable with both monomers that are “a monomer that becomes the N-substituted maleimide unit (a) by polymerization” and “a monomer that becomes the (meth)acrylate ester unit (b) by polymerization”. Examples of the structural unit (C) include structural units derived from monomers such as acrylic acid, methacrylic acid, crotonic acid, maleic anhydride, 2-(hydroxymethyl)acrylate, 2-(hydroxyethyl)acrylate, cyclohexyl (meth)acrylate, benzyl (meth)acrylate, dicyclopentanyl (meth)acrylate, dicyclopentanyl oxyethyl (meth)acrylate, styrene, vinyl toluene, α-methylstyrene, α-hydroxy methylstyrene, α-hydroxy ethylstyrene, acrylonitrile, methacrylonitrile, methallyl alcohol, allyl alcohol, ethylene, propylene, 4-methyl-1-pentene, vinyl acetate, 2-hydroxymethyl-1-butene, methyl vinyl ketone, N-vinylpyrrolidone, and N-vinylcarbazole. The acrylic polymer may include two or more structural units (c). In addition, the structural unit (c) can be added to the acrylic polymer, for example, in order to suppress excessive increase in the glass transition temperature Tg of the acrylic polymer.

The above-described acrylic polymer suitably used as the first resin can be obtained by copolymerizing monomer structural units as mentioned above. The method for polymerization is not particularly limited, and the acrylic polymer can be produced by a method such as, for example, bulk polymerization, suspension polymerization, emulsion polymerization, or solution polymerization. Among these methods, suspension polymerization is suitable from the viewpoint that processing after polymerization is easy and heating or the like for removing an organic solvent is unnecessary in the processing after polymerization. Conditions for suspension polymerization are not particularly limited and known conditions for suspension polymerization can be applied as appropriate. Hereinafter, an embodiment of a process for producing the acrylic polymer by suspension polymerization will be described. However, the present invention is not limited to the following one example.

First, each monomer is weighed to give a desired mass ratio. Then, 300 parts by mass of deionized water and 0.6 parts by mass of polyvinyl alcohol (KURARAY POVAL, manufactured by Kuraray Co., Ltd.,) as a dispersant with respect to 100 parts by mass in total of the monomers are charged into a suspension polymerization apparatus, and stirring is started. Next, the weighed monomers, 1 part by mass of PEROYL TCP as a polymerization initiator, manufactured by NOF Corporation, and 0.22 parts by mass of 1-octanethiol as a chain transfer agent are charged into the suspension polymerization apparatus.

After that, the temperature of the reaction system is increased up to 70° C. while passing nitrogen through the suspension polymerization apparatus. Then, the reaction system is kept at 70° C. for 3 hours to allow it to react. After the reaction, the reaction system is cooled down to room temperature, and then subjected to operations such as filtration, washing, and drying as needed, thereby obtaining an acrylic copolymer in particle form.

The resin forming the dispersed phase 3 (hereinafter referred to as “second resin” in some cases) is not particularly limited as long as it is a resin that is incompatible with the first resin forming the continuous phase 1 and can cause optical anisotropy. The second resin is preferably a liquid crystal polymer, and more preferably a bar-shaped liquid crystal polymer. A known liquid crystal polymer can be used as the liquid crystal polymer, and is available by selecting as appropriate, for example, from a polymer liquid crystal described in Japanese Unexamined Patent Application Publication No. 2000-73063, a liquid crystal polymer described in Japanese Unexamined Patent Application Publication No. 2004-70345, and the like.

Examples of the resin forming the dispersed phase 3 include liquid crystalline polyesters, liquid crystalline polypeptides, liquid crystalline polysilanes, (meth)acrylic side-chain liquid crystal polymers, polycarbonates, polyethylene terephthalates, polynaphthalene terephthalates, cycloolefin polymers, and polystyrenes. Among them, from the viewpoint of having a large optical anisotropy, liquid crystalline polyesters, liquid crystalline polypeptides, liquid crystalline polysilanes, polyethylene terephthalates, and polynaphthalene terephthalates are preferable, and liquid crystalline polyesters, polyethylene terephthalates, and polynaphthalene terephthalates are more preferable.

In one suitable embodiment, an absolute value |T₁−T₂| of a difference between a glass transition temperature T₁ of the first resin and a glass transition temperature T₂ of the second resin is below 25° C. In addition, the difference |T₁−T₂| may be below 15° C. or may be below 10° C.

With the combination of the first resin and the second resin satisfying such a relationship between the glass transition temperatures, an optical film including the dispersed phase 3 with a large ratio: L₁/L₂ can be obtained by the process for the producing the optical film as described later. Thus, such a combination of the first resin and the second resin can achieve an optical film that can more remarkably exhibit the brightness enhancement effect.

In addition, when the glass transition temperature T₁ of the first resin is too low with respect to the glass transition temperature T₂ of the second resin, fluidity of the second resin in melt extrusion cannot be sufficiently obtained at a film forming step to be described later, and the ratio: L₁/L₂ of the dispersed phase 3 cannot be made sufficiently large, as a result of which the brightness enhancement effect of the obtained optical film sometimes becomes low. In addition, when the glass transition temperature T₁ of the first resin is too high with respect to the glass transition temperature T₂ of the second resin, high temperature is needed for melt extrusion at the film forming step to be described later. Due to this, the degree of orientation of the second resin in the dispersed phase 3 is reduced, and thereby scattering of the polarized component of the direction D₂ by the dispersed phase 3 may not be able to be sufficiently attained.

Additionally, preferably, the glass transition temperature T₂ of the second resin is lower than the glass transition temperature T₁ of the first resin. In other words, preferably, the glass transition temperatures T₁ and T₂ satisfy 0° C.<T₁−T₂<20° C. With such a combination of the first resin and the second resin, the second resin is sufficiently melted at a temperature at which the first resin is melted at the film forming step to be described later, thereby further ensuring that the dispersed phase 3 with a large ratio: L₁/L₂ can be obtained.

Additionally, in the present specification, the glass transition temperatures each represent a value obtained from an on-set temperature of a glass transition point at a time when temperature is increased at a temperature increase rate of 10° C./min by using a differential scanning calorimeter DSC 7020 manufactured by SII Nanotechnology Inc. In addition, specimens have a weight of from 5 to 10 mg.

Additionally, preferably, the first resin and the second resin satisfy the following formulae (A-1) and (A-2):

N₂−N₁>0.19 (A-1)

|N₁−N₃|<0.09 (A-2)

In the formulae (A-1) and (A-2), N₁ represents a refractive index of the first resin forming the continuous phase 1; N₂ represents a refractive index of the second resin in an orientation direction in which the second resin forming the dispersed phase 3 is oriented on an orientation substrate; and N₃ represents a refractive index of the second resin in a direction orthogonal to the orientation direction in a plane including the orientation direction in which the second resin forming the dispersed phase 3 is oriented on the orientation substrate.

When the first resin and the second resin satisfy the above formula (A-1), the refractive index with respect to the polarized component of the direction D₁ is largely different between the continuous phase 1 and the dispersed phase 3, so that the polarized component of the direction D₂ can be scattered with higher efficiency. Additionally, when the first resin and the second resin satisfy the above formula (A-2), the refractive index with respect to the polarized component of the direction D₂ is the same level between the continuous phase 1 and the dispersed phase 3, so that the polarized component of the direction D₁ can be supplied to the absorption type polarizer with higher efficiency. Thus, the brightness enhancement effect can be obtained more remarkably.

A difference N₂−N₁ between the refractive index N₂ and the refractive index N₁ is more preferably above 0.2, and still more preferably above 0.3. In addition, an absolute value |N₁−N₃| of a difference between the refractive index N₁ and the refractive index N₃ is more preferably below 0.07, and still more preferably below 0.06.

The content percentage of the dispersed phase 3 in the optical film 10 is preferably from 1 to 50% by mass, and more preferably from 2 to 30% by mass, based on a total volume of the optical film 10. When the dispersed phase 3 is dispersed in the continuous phase 1 in such a content percentage, the mean Feret diameter L₂ of the dispersed phase 3 can be made smaller.

The thickness of the optical film 10 is not particularly limited, but can be set to, for example, from 10 to 200 μm, and is preferably from 20 to 100 μm.

### (Process for Producing Optical Film)

Next, a detailed description will be given of one embodiment of a process for producing an optical film according to the present invention.

The process for producing an optical film according to the invention includes a film forming step of forming a film by melting a resin material that includes the first resin forming the continuous phase 1 and the second resin forming the dispersed phase 3 and continuously discharging the resin material from a T die.

The film forming step can be performed, for example, by continuously discharging the melted resin material from the T die onto a cooling roll. At this time, the resin material discharged on the cooling roll is cooled by the cooling roll and rolled up as a film onto a take-up roll.

Herein, a melting temperature T₀ (° C.) of the resin material is, when the glass transition temperature of the first resin is T₁ (° C.), preferably T₁+30° C.<T₀<T₁+250° C., and more preferably T₁+50° C.<T₀<T₁+200° C. Setting to such a melting temperature allows the first resin and the second resin to sufficiently flow, thereby allowing producing of an optical film in which the second resin is dispersed in the first resin.

In the process of the present embodiment, at the film forming step, the resin material discharged from the T die is preferably extended and deformed so that a ratio: d₂/d₁ of a film thickness d₂ of a film to be formed to a lip clearance d₁ of the T die is below 0.5. Thereby, the ratio: L₁/L₂ of the dispersed phase 3 to be formed can be made sufficiently large. Such extension and deformation can be performed by adjusting as appropriate, for example, the rage of discharging of the resin material from the T die and the rate of rolling up thereof by the cooling roll and the take-up roll.

The lip clearance d₁ of the T die is a gap of a slit through which the melted resin is discharged, and when d₁ becomes large, a film of the melted resin immediately after having been discharged becomes thick. The film thickness d₂ of a film to be formed is the film thickness of a film after having been cooled and solidified at the film forming step. The ratio: d₂/d₁ of below 0.5 means that the film of the melted resin has been largely extended and deformed at the film forming step.

The film obtained at the film forming step can be directly used as an optical film, but more preferably is used as an optical film after passing through the stretching step to be described later.

In other words, the process according to the present invention may further include a stretching step of at least unidirectionally stretching a film (hereinafter referred to as “web film” in some cases) formed at the film forming step. Such a stretching step can improve mechanical strengths (such as tearing resistance and folding endurance) of an optical film and can further improve optical characteristics.

At the stretching step, preferably, the web film is uniaxially stretched in the same direction as a machine direction of the web film. By performing such a stretching, the ratio: L₁/L₂ of the dispersed phase 3 can be made larger, so that an optical film having a better brightness enhancement effect can be obtained.

When the glass transition temperature of the first resin is T₁ (° C.), the temperature for stretching can be, for example, T₁ or more and T₁+70° C. or less, or may be T₁ or more and T₁+40° C. or less. By setting to such a stretching temperature, the mechanical strengths of the optical film can be further improved, and optical characteristics thereof can be further improved.

A stretch ratio can be set as appropriate depending on required mechanical strengths, and for example, can be from 1.2 to 8.0 times, or can be from 1.3 to 6.0 times.

### (Polarizing Plate)

A polarizing plate according to the present invention includes an absorption type polarizer and the above-described optical film, and in the polarizing plate according to the invention, the optical film functions as a brightness enhancement film.

In the polarizing plate according to the present invention, the optical film is disposed on one surface of an absorption type polarizer. When applying the polarizing plate to a liquid crystal display device, the polarizing plate is located so that light from a backlight is input to the absorption type polarizer via the optical film.

In addition, in the polarizing plate according to the present invention, constituent elements other than the optical film and the absorption type polarizer are not particularly limited, and can be the same as those of known polarizing plates. For example, the polarizing plate may further include a protecting film, an optical compensation film, and the like, as needed.

### (Liquid Crystal Display Device)

A liquid crystal display device according to the present invention includes the above-described optical film, and the optical film functions as a brightness enhancement film in the liquid crystal display device according to the invention.

In the liquid crystal display device according to the present invention, constituent elements other than the optical film are not particularly limited, and the liquid crystal display device can have the same structure as known liquid crystal display devices including a brightness enhancement film. For example, the liquid crystal display device according to the invention may have a structure in which a glass substrate, an absorption type polarizer, the above-described optical film, a prism sheet, a scattering plate, a backlight, a reflecting sheet, and the like are sequentially laminated.

The polarizing plate and the liquid crystal display device according to the present invention include the above-described optical film as the brightness enhancement film, so that an excellent brightness enhancement effect can be obtained.

### (Polarizing Projection Screen)

A polarizing projection screen according to the present invention includes the above-described optical film. In the polarizing projection screen according to the invention, constituent elements other than the optical film are not particularly limited, and the polarizing projection screen can have the same structure as the known projection screens. For example, the polarizing projection screen may further include a lenticular lens, a Fresnel lens, a light scattering plate, and the like, as needed.

The polarizing projection screen according to the present invention can project a clear image that is hardly affected by ambient light and also can further widen a viewing angle of a projected image as compared to the conventional absorption type polarizing layer. Additionally, the polarizing projection screen according to the invention can also be applied as a three-dimensional display screen as described in Japanese Unexamined Patent Application Publication No. 2010-85617.

While some suitable embodiments of the present invention have been described hereinabove, the invention is not limited to the above embodiments.

### EXAMPLES

Hereinafter, the present invention will be described more specifically by way of Examples. However, the invention is not limited to the Examples.

### Example 1

### (1) Synthesis of First Resin Forming Optically Isotropic Continuous Phase

Into a reaction vessel equipped with a stirring device, a thermosensor, a condenser tube, and a nitrogen introducing tube, 300 parts by mass of deionized water and 0.6 parts by mass of polyvinyl alcohol (Kuraray POVAL, manufactured by Kuraray Co., Ltd.,) as a dispersant were charged together, and stirring was started. Next, 85 parts by mass of methyl methacrylate (MMA), 15 parts by mass of N-cyclohexyl maleimide (CHMI), 1 part by mass of PEROYL TCP as a polymerization initiator, manufactured by NOF Corporation, and 0.22 parts by mass of 1-octanethiol as a chain transfer agent were charged thereinto. Then, the temperature was raised to 70° C. while introducing nitrogen through the tube. The state of the reaction mixture after reaching 70° C. was kept for 3 hours, and then the mixture was cooled down, followed by filtration, washing, and drying, thereby obtaining an acrylic polymer in particle form.

The obtained acrylic polymer had a weight average molecular weight of 1.5×10⁵ and a glass transition temperature Tg of 125° C. In addition, the refractive index N₁ in an unoriented state was 1.501. Additionally, the weight average molecular weight Mw represents a value measured in terms of standard polystyrene molecular weight using HLC-8220 GPC manufactured by Tosoh Corporation. In addition, columns used in GPC can be Super-Multipore HZ-M manufactured by Tosoh Corporation, and measurement conditions were tetrahydrofuran (THF) for HPLC as a solvent; a flow rate of 0.35 ml/min; and a column temperature of 40° C. Additionally, Tg was obtained from an on-set temperature of a glass transition point at a time when temperature was raised at a temperature rising rate of 10° C./min using a differential scanning calorimeter DSC 7020 manufactured by SIT Nanotechnology Inc. The mass of specimen of the acrylic copolymer was from 5 mg or more and 10 mg or less. In addition, the refractive index N₁ in the unoriented state was obtained by producing a film with a film thickness of 200 μm by a hot press machine and measuring the obtained film by an Abbe's refractometer.

### (2) Evaluation of Birefringence of Continuous Phase Formed from First Resin

The acrylic polymer obtained in the above (1) was formed into a film by a twin-screw extruder KZW-30MG manufactured by Technovel Corporation. The twin-screw extruder has a screw diameter of 15 mm and a screw effective length (L/D) of 30, and has a coat-hanger type T die disposed via an adapter. A web film was obtained at an extrusion temperature of 240° C., a screw rotation rate of 355 rpm, and a film molding take-up roll rate of 3 m/min. While the lip clearance of the T die was 170 μm, the thickness of the web film was 80 μm.

The obtained web film was subjected to free-end uniaxial stretching in the same direction as a machine direction of the web film by a batch type stretching machine manufactured by Imoto Machinery Co., Ltd (stretch temperature: Tg+9° C.; stretch ratio: 1.4 times). The thickness of the obtained stretched film was 60 μm. The in-plane phase difference Re thereof measured by Axoscan was 7.2 nm. In other words, the birefringence index was 1.2×10⁻⁴, which was very small. This is because the composition ratio of the copolymer was adjusted so that the negative intrinsic birefringence of PMMA was cancelled by the positive intrinsic birefringence of PCHMI. Specifically, it was because the charged proportion of each monomer was adjusted to give a ratio of MMA:CHMI=85:15.

### (3) Synthesis of Second Resin Forming Optically Anisotropic Dispersed Phase

A liquid crystalline polyester as a main chain type liquid crystal polymer was synthesized by the following method.

Specifically, using 20 mmol of terephthalic acid, 20 mmol of 2,6-naphthalene dicarboxylic acid, 40 mmol of catechol diacetate, 10 mmol of p-acetoxy benzoic acid, and 20 mmol of 6-acetoxy-2-naphthoic acid, polymerization was performed in a nitrogen atmosphere at 260° C. for 4 hours, at 290° C. for 2 hours, and subsequently in a nitrogen gas flow of 100 ml per minute at 290° C. for 4 hours, thereby obtaining a liquid crystalline polyester. The obtained liquid crystalline polyester had a glass transition temperature of 112° C.

### (4) Evaluation of Refractive Index of Second Resin

In addition, a solution of 10% by mass of the liquid crystalline polyester dissolved in a phenol/tetrachloroethane mixed solvent (6:4 weight ratio) was prepared. The solution was applied on a high refractive index glass substrate provided with a rubbing polyimide film, by a spin coater. The coated film was dried, then thermally processed at 220° C. for 5 minutes, and returned to the room temperature to obtain a uniformly oriented liquid crystalline thin film. The refractive index of the uniformly oriented liquid crystalline thin film was measured by an Abbe's refractometer, as a result of which the refractive index N₂ in a rubbing direction was 1.82, and the refractive index N₃ in a direction perpendicular to the rubbing direction and a film thickness direction was 1.58.

### (5) Production of Optical Film

A powder of the liquid crystalline polyester obtained in the above (3) was added at a mass ratio of 3% to a powder of the acrylic polymer obtained in the above (1), and the powders were uniformly mixed at room temperature. After the mixing, the mixture was charged into a hopper of a twin-screw extruder KZW-30MG manufactured by Technovel Corporation to form a web film, as in the above (2). In addition, as in the (2), the screw diameter of the twin-screw extruder is 15 mm and the screw effective length (L/D) thereof is 30. The extruder is provided with a coat-hanger type T die via an adapter. Additionally, the extrusion temperature was set to 240° C., the screw rotation rate was set to 355 rpm, and the film molding take-up roll rate was set to 3 m/min. While the lip clearance of the T die was 170 μm, the thickness of the web film was 80 μm.

The obtained web film was subjected to free-end uniaxial stretching in the same direction as a machine direction of the web film by a batch type stretching machine manufactured by Imoto Machinery Co., Ltd (stretch temperature: 134° C. (continuous phase Tg+9° C.); stretch ratio: 1.4 times), thereby obtaining an optical film. The obtained optical film had a thickness of 60 (μm).

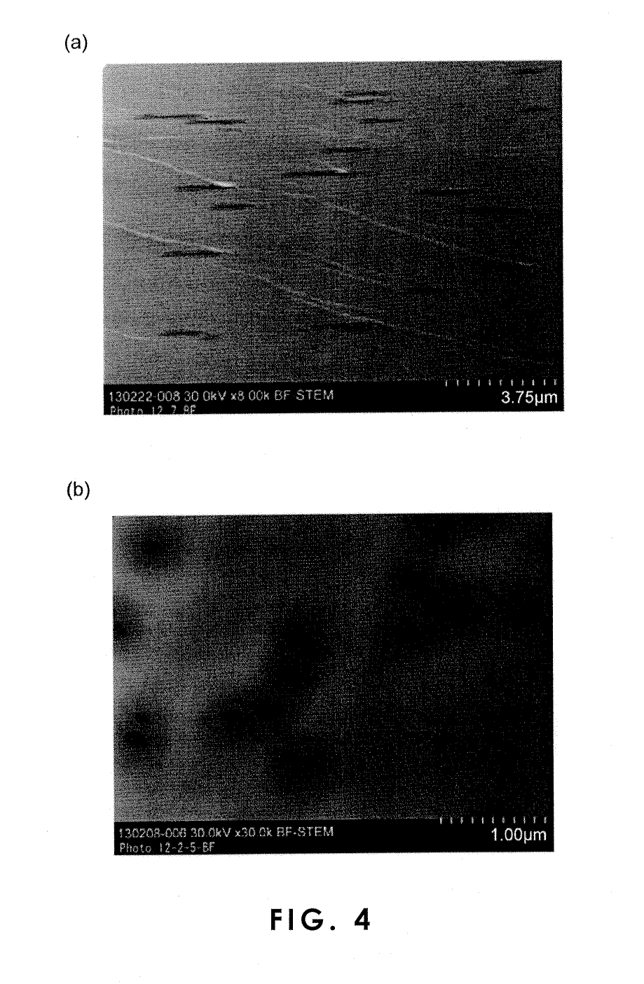

A section of the obtained optical film was observed through a scanning electron microscope (SEM) to measure the mean Feret diameter L₁, and the mean Feret diameter L₂ of the dispersed phase. Specifically, a section parallel to a machine direction of the optical film was observed through the SEM. In randomly selected 10 dispersed phases, there were obtained distances between line segments when they were sandwiched by the two line segments parallel to the thickness direction D₃, and an average value of the distances was regarded as the mean Feret diameter L₁. In addition, a section perpendicular to the machine direction of the optical film was observed through the SEM, and in randomly selected 10 dispersed phases, there were obtained distances between line segments when they were sandwiched by the two line segments parallel to the thickness direction D₃, and an average value of the distances was regarded as the mean Feret diameter L₂. The measured mean Feret diameters L₁ and L₂ were 1.5 μm and 0.15 μm, and the ratio: L₁/L₂ was 10. Additionally, FIG. 4(a) is a view showing a SEM observation photograph of the section parallel to the machine direction of the optical film of Example 1, and FIG. 4(b) is a view showing a SEM observation photograph of the section perpendicular to the machine direction of the optical film thereof.

### (6) Evaluation of Brightness Enhancement Rate of Optical Film

In a stable state of luminance of a backlight (FUJICHROME VIEWER 5000 manufactured by Fujifilm Co., Ltd.), luminance measurement was performed 5 times by a luminance meter (CHROMA MATER CS100A manufactured by Konica Minolta Inc.) at a position 1 m away from the front of a light source unit with the backlight and an absorption type polarizing plate disposed in this order, and an average value of the measured results was obtained as blank luminance. Next, luminance was similarly measured using a light source unit with the backlight, a brightness enhancement film sample, and an absorption type polarizing plate disposed in this order, and an improvement rate with respect to the blank luminance was used as a brightness enhancement rate (%) to perform evaluation. In this case, the stretching direction of the optical film sample was arranged to be aligned with the direction of an absorption axis of the absorption type polarizing plate. As a result, the brightness enhancement rate was 10.5%.

### (7) Evaluation of Image Visibility in Use as Polarizing Projection Screen

An absorption type polarizing plate made of iodine-impregnated PVA was located at a position 2 cm away from an image projection lens of a mobile LED mini projector PP-D1S manufactured by Onkyo Digital Solutions Corporation, and preparation was made so that only one polarized component was projected from the projector. The obtained brightness enhancement film was located at a position 30 cm away from the absorption type polarizing plate, and a focus knob of the projector is adjusted so that the position of the brightness enhancement film comes into focus. Visual evaluation was made with regard to visibility of an image projected on the brightness enhancement film from two points at a slant angle of 45 degrees backward and a slant angle of 45 degrees forward of the brightness enhancement film. When the brightness enhancement film was located so that a scattering axis of the brightness enhancement film, i.e., an MD direction thereof (note: a long axis direction of the optically anisotropic dispersed phase) was orthogonal to the absorption axis of the PVA absorption type polarizing plate, an image projected from the projector clearly appeared on the brightness enhancement film. On the other hand, when the brightness enhancement film was located so that the scattering axis of the brightness enhancement film was parallel to the absorption axis of the PVA absorption type polarizing plate, no image was visually recognizable. Thus, the film was applicable as a polarizing projection screen on which an image is projected by scattering only a one-directional polarized component.

### Example 2

An optical film was produced in the same manner as in Example 1 except that the stretching temperature of the web film of the above (5) was changed to 144° C. In addition, when the evaluation of the above (2) was made by changing the stretching temperature to 144° C., the Re was 6.9 nm and the birefringence was 1.5×10⁻⁴.

In addition, in the obtained optical film, the dispersed phase had a mean Feret diameter L₁ of 1.5 μm and a mean Feret diameter L₂ of 0.15 μm, in which the ratio thereof: L₁/L₂ was 10. Additionally, the brightness enhancement rate measured in the same manner as in the above (6) was 9.8%.

In addition, when the obtained optical film was evaluated in the same manner as the image visibility evaluation in the use as the polarizing projection screen of Example 1, the film was applicable as a polarizing projection screen on which an image is projected by scattering only a one-directional polarized component.

### Example 3

An optical film was obtained in the same manner as in Example 1 except that in the method for synthesizing the first resin forming the optical isotropic continuous phase, the composition of the resin contained 81 parts by mass of methyl methacrylate (MMA), 11 parts by mass of N-cyclohexyl maleimide (CHMI), and 8 parts by mass of N-phenyl maleimide (PhMI). The obtained acrylic polymer had a weight average molecular weight of 1.5×10⁵ and a Tg of 130° C. In addition, the refractive index N₁ in an unoriented state was 1.502. When the obtained web film was subjected to free-end uniaxial stretching in the same direction as a machine direction of the web film by a batch type stretching machine manufactured by Imoto Machinery Co., Ltd (stretch temperature: continuous phase Tg+9° C. (139° C.); stretch ratio: 1.4 times), the film had an in-plane phase difference Re of 4.8 nm. In other words, the birefringence thereof was 8.0×10⁻⁵, which was very small. This is because the composition ratio of the copolymer was adjusted so that the negative intrinsic birefringence of PMMA was cancelled by the positive intrinsic birefringences of poly(N-cyclohexyl maleimide) (CHMI) and poly(N-phenyl maleimide) (PhMI).

In the optical film with the dispersed phase added therein, the dispersed phase had a mean Feret diameter L₂ of 1.4 μm and a mean Feret diameter L₂ of 0.15 μm in which the ratio: L₁/L₂ was 9.3. The brightness enhancement rate was 10.2%.

In addition, when the obtained optical film was evaluated in the same manner as the image visibility evaluation in the use as the polarizing projection screen of Example 1, the film was applicable as a polarizing projection screen on which an image is projected by scattering only a one-directional polarized component.

### Example 4

An optical film was obtained in the same manner as in Example 1 except that in the method for synthesizing the first resin forming the optical isotropic continuous phase, the composition of the resin contained 88 parts by mass of methyl methacrylate (MMA) and 12 parts by mass of phenoxyethyl acrylate. The obtained acrylic polymer had a weight average molecular weight of 1.5×10⁵ and a Tg of 100° C. In addition, the refractive index N₁ in an unoriented state was 1.493. When the obtained web film was subjected to free-end uniaxial stretching in the same direction as a machine direction of the web film by a batch type stretching machine manufactured by Imoto Machinery Co., Ltd (stretch temperature: dispersed phase Tg+9° C. (121° C.); stretch ratio: 1.4 times), the film had an in-plane phase difference Re of 4.8 nm. In other words, the birefringence thereof was 8.0×10⁻⁵, which was very small. This is because the composition ratio of the copolymer was adjusted so that the negative intrinsic birefringence of PMMA was cancelled by the positive intrinsic birefringence of polyphenoxyethyl acrylate.

In the optical film with the dispersed phase added therein, the dispersed phase had a mean Feret diameter L₁ of 1.5 μm and a mean Feret diameter L₂ of 0.20 μm, in which the ratio: L₁/L₂ was 7.5. The brightness enhancement rate was 9%.

In addition, when the obtained optical film was evaluated in the same manner as the image visibility evaluation in the use as the polarizing projection screen of Example 1, the film was applicable as a polarizing projection screen on which an image is projected by scattering only a one-directional polarized component.

### Comparative Example 1

A web film was obtained in the same manner as in Example 1 except that a commercially available resin SD 2201W (Tg: 137° C.; refractive index in an unoriented state: 1.582) manufactured by Sumika Styron Polycarbonate, Ltd., was used as the first resin. In addition, the evaluation of the above (2) was made with regard to the SD 2201W, as a result of which the Re was 450 nm, i.e., the birefringence was 7.5×10⁻³.

The obtained web film was subjected to free-end uniaxial stretching in the same direction as the machine direction of the web film by a batch type stretching machine manufactured by Imoto Machinery Co., Ltd (stretch temperature: 146° C. (continuous phase Tg+9° C.); stretch ratio: 1.4 times), thereby obtaining an optical film. The obtained optical film had a thickness of 60 μm.

In addition, in the obtained optical film, the dispersed phase had a mean Feret diameter L₁ of 0.40 μm and a mean Feret diameter L₂ of 0.08 μm, in which the ratio: L₁/L₂ was 5.0. Additionally, the brightness enhancement rate measured in the same manner as in the above (6) was 1.3%.

In addition, when the obtained optical film was evaluated in the same manner as the image visibility evaluation in the use as the polarizing projection screen of Example 1, an image projected when the optical film was located so that the scattering axis was orthogonal to the absorption axis of the PVA absorption type polarizing plate had lower contrast and less clarity than in Examples 1 to 4. Additionally, even when the optical film was located so that the scattering axis was parallel to the absorption axis of the PVA absorption type polarizing plate, an image was visually recognizable but unclear. Accordingly, as a polarizing projection screen on which an image is projected by scattering only a one-directional polarized component, the film was inferior to those of Examples 1 to 4.

### Comparative Example 2

An optical film was produced in the same manner as in Comparative Example 1 except that the stretching temperature of the web film of the above (5) was changed to 156° C. In addition, when the evaluation of the above (2) was made by changing the stretching temperature to 156° C., the Re was 420 nm, i.e., the birefringence was 7.0×10⁻³.

In addition, in the obtained optical film, the dispersed phase had a mean Feret diameter L₁ of 0.38 μm and a mean Feret diameter L₂ of 0.1 μM, in which the ratio: L₁/L₂ was 3.8. Additionally, the brightness enhancement rate measured in the same manner as in the above (6) was 0.8%.

In addition, when the obtained optical film was evaluated in the same manner as the image visibility evaluation in the use as the polarizing projection screen of Example 1, an image projected when the optical film was located so that the scattering axis was orthogonal to the absorption axis of the PVA absorption type polarizing plate had lower contrast and less clarity than in Examples 1 to 4. Additionally, even when the optical film was located so that the scattering axis was parallel to the absorption axis of the PVA absorption type polarizing plate, an image was recognizable, although it was unclear. Accordingly, as a polarizing projection screen on which an image is projected by scattering only a one-directional polarized component, the film was inferior to those of Examples 1 to 4.

### Comparative Example 3

An optical film was produced in the same manner as in Example 1 except that in the production of the optical film of the above (5), a web film with a thickness of 80 μm was obtained at a T-die lip clearance of 100 μm, a screw rotation rate of 100 rpm, and a film molding take-up roll rate of 1 m/min.

In the obtained optical film, the dispersed phase had a mean Feret diameter L₁ of 1.2 μm and a mean Feret diameter L₂ of 0.55 μm, in which the ratio: L₁/L₂ was 2.18. This seems to be due to the fact that extension and deformation of the melted resin discharged from the T-die lip was small. Additionally, the brightness enhancement rate measured in the same manner as in the above (6) was 4.5%.

In addition, when the obtained optical film was evaluated in the same manner as the image visibility evaluation in the use as the polarizing projection screen of Example 1, an image projected when the optical film was located so that the scattering axis was orthogonal to the absorption axis of the PVA absorption type polarizing plate had lower contrast and less clarity than in Examples 1 to 4. Additionally, even when the optical film was located so that the scattering axis was parallel to the absorption axis of the PVA absorption type polarizing plate, an image was recognizable, although it was unclear. Accordingly, as a polarizing projection screen on which an image is projected by scattering only a one-directional polarized component, the film was inferior to those of Examples 1 to 4.

### Comparative Example 4

Using 40 mmol of terephthalic acid, 20 mmol of catechol diacetate, and 20 mmol of methyl hydroquinone diacetate, polymerization was performed in a nitrogen atmosphere at 260° C. for 4 hours, at 290° C. for 2 hours, and subsequently in a nitrogen gas flow of 100 ml per minute at 290° C. for 4 hours, thereby obtaining a liquid crystalline polyester. The obtained liquid crystalline polyester had a Tg of 97° C. Additionally, the obtained liquid crystalline polyester was subjected to the same refractive index evaluation as the refractive index evaluation of the above (2), as a result of which the refractive index N₂ in a rubbing direction was 1.82 and the refractive index N₃ in a direction perpendicular to the rubbing direction and a film thickness direction was 1.58.

An optical film was produced in the same manner as in Comparative Example 3 except that the liquid crystalline polyester was used as the second resin. In the obtained optical film, the dispersed phase had a mean Feret diameter L₁ of 1.2 μm and a mean Feret diameter L₂ of 0.55 in which the ratio: L₁/L₂ was 2.18. This seems to be due to the fact that since the Tg of the liquid crystalline polyester as the second resin was low and thus the difference between the Tg and the Tg of the acrylic polymer forming the continuous phase was large, the birefringence of the dispersed phase became small. In addition, the brightness enhancement rate measured in the same manner as in the above (6) was 1.5%.

In addition, when the obtained optical film was evaluated in the same manner as the image visibility evaluation in the use as the polarizing projection screen of Example 1, an image projected when the optical film was located so that the scattering axis was orthogonal to the absorption axis of the PVA absorption type polarizing plate had lower contrast and less clarity than in Examples 1 to 4. Additionally, even when the optical film was located so that the scattering axis was parallel to the absorption axis of the PVA absorption type polarizing plate, an image was recognizable, although it was unclear. Accordingly, as a polarizing projection screen on which an image is projected by scattering only a one-directional polarized component, the film was inferior to those of Examples 1 to 4.

### REFERENCE SIGNS LIST

1 . . . Optically isotropic continuous phase
3 . . . Optically anisotropic dispersed phase
10 . . . Optical film

1. An optical film comprising an optically isotropic continuous phase and an optically anisotropic dispersed phase, wherein:
the optically isotropic continuous phase has a birefringence of below 1.5×10⁻⁴;
a ratio: L₁/L₂ of a mean Feret diameter L₁ of the optically anisotropic dispersed phase in one direction D₁ of in-plane directions of the optical film to a mean Feret diameter L₂ of the optically anisotropic dispersed phase in a direction D₂ orthogonal to the direction D₁ is 2.5 or more; and
the mean Feret diameter L₂ is 0.5 μm or less.

2. The optical film according to claim 1, wherein the direction D₁ is a machine direction MD of the optical film and the direction D₂ is a transverse direction TD of the optical film.

3. The optical film according to claim 1, wherein the optically anisotropic dispersed phase may include a bar-shaped liquid crystal polymer.

4. The optical film according to claim 3, wherein a refractive index N₁ of a resin forming the optically isotropic continuous phase,
a refractive index N₂ in an orientation direction in which the bar-shaped liquid crystal polymer is oriented on an orientation substrate, and a refractive index N₃ in a direction orthogonal to the orientation direction in a plane including the orientation direction satisfy the following formulae (A-1) and (A-2):
N₂−N₁>0.19 (A-1)

|N₁−N₃|<0.09 (A-2).

5. The optical film according to claim 1, wherein a difference |T₁−T₂| between a glass transition temperature T₁ of the resin forming the optically isotropic continuous phase and a glass transition temperature T₂ of the resin forming the optically anisotropic dispersed phase is below 25° C.

6. A process for producing the optical film according to claim 1, comprising a film forming step of forming a film by melting a resin material that includes a first resin forming the optically isotropic continuous phase and a second resin forming the optically anisotropic dispersed phase and continuously discharging the resin material from a T die.

7. The process according to claim 6, wherein at the film forming step, the resin material discharged from the T die is extended and deformed so that a ratio: d₂/d₁ of a film thickness d₂ of a film to be formed to a lip clearance d₁ of the T die is below 0.5.

8. The process method according to claim 6, further comprising a stretching step of at least unidirectionally stretching the film formed at the film forming step.

9. A polarizing plate comprising the optical film according to claim 1 and an absorption type polarizer.

10. A liquid crystal display device comprising the optical film according to claim 1.

11. A polarizing projection screen comprising the optical film according to claim 1.
